(19) United States
(12) Patent Application Publication
(10) Pub. No.: US 2026/0126278 A1
(43) Pub. Date: May 7, 2026

(54) ARROW TRACKING SYSTEM

(71) Applicants: George T. Murray, Pinetop, AZ (US); Brandon Davis, Queen Creek, AZ (US)

(72) Inventors: George T. Murray, Pinetop, AZ (US); Brandon Davis, Queen Creek, AZ (US)

(21) Appl. No.: 19/380,225

(22) Filed: Nov. 5, 2025

Related U.S. Application Data
(60) Provisional application No. 63/716,647, filed on Nov. 5, 2024.

(51) Int. Cl. F42B 12/38; H04W 4/029

(52) U.S. Cl. CPC F42B 12/385; H04W 4/029

(57) ABSTRACT

The present invention pertains to an arrow tracking system that enables a user to locate an arrow after it has been launched. The system includes a nock with an inner housing designed to enclose a GPS module controlled by a micro-controller (MCU). The MCU is activated by a plunger sliding within the nock and also controls a light signaling GPS activation. In certain embodiments, the system comprises a two-unit configuration with a transmitter unit housed within the nock and a receiving unit carried by the user. The transmitter unit includes a nock GPS module, transceiver, and plunger-activated switch. The receiving unit includes a receiving controller coupled to a receiver GPS module and transceiver that calculates distance and directional bearing between units. The receiving unit displays real-time positioning on topographical maps via an integrated screen or mobile device, enabling efficient arrow recovery.

### FIELD OF THE INVENTION

This application claims benefit of U.S. provisional Pat. App. No. 63/716,647 title ARROW TRACKING SYSTEM and filed Nov. 5, 2024, the entirety of which is hereby incorporated by reference.

The described technology pertains to the field of archery equipment, with a focus on an arrow tracking system that integrates a global positioning system (GPS) within the arrow's nock. It utilizes components such as a micro-controller, switch, and wireless communication interface to facilitate real-time tracking and efficient operation of GPS-enabled arrows.

### BACKGROUND OF THE INVENTION

The field of arrow tracking technology has increasingly focused on enhancing the locational awareness of arrows post-launch, particularly in activities such as archery and hunting. Archery enthusiasts, whether they are hunters or sportsmen, often encounter the problem of losing their arrows after they have been shot. This can be particularly frustrating and costly, as arrows are not always easily recoverable and may require replacement. In the case of hunting, a lost arrow can also mean a lost game, adding to the frustration. Furthermore, if an arrow is shot and wounds an animal without immediately incapacitating it, the animal may escape, leading to unnecessary suffering and the loss of meat for the hunter.

Traditional methods of tracking arrows have typically relied on visual cues or manual retrieval, which can be unreliable and inefficient, especially in dense terrains or low-light environments. The integration of technology into arrow components aims to address these limitations by providing more precise and reliable tracking mechanisms.

Current tracking solutions in the domain primarily involve lighted nocks, which provide a visual aid to locate arrows but are inherently limited by visibility conditions and distance. These solutions do not offer location data beyond line-of-sight observation, posing challenges when retrieving arrows in thick vegetation or over long distances where visual tracking becomes ineffective. Furthermore, batteries in existing lighted nocks can deplete rapidly, and there is often no mechanism to ensure nock activation only when necessary, leading to inefficient battery usage and increased operational costs.

Efforts to integrate tracking technologies such as GPS into arrow systems have encountered several technical obstacles. Challenges include the miniaturization of components to fit within the constricted space of an arrow's nock, energy management to prolong the operation lifecycle of the GPS module and ensuring the resilience of electronic components during the release and flight of the arrow and adding unnecessary weight to the nock of the arrow which can affect the flight and trajectory of the arrow. Additionally, existing GPS systems lack a reliable method for activation control, which is crucial for conserving battery life and ensuring functionality only during arrow deployment.

What is needed is an advanced system that integrates GPS technology within the nock of an arrow, enabling real-time location tracking post-launch. This system should be capable of activating the GPS module only upon proper nocking onto the bowstring to conserve battery life. Moreover, the system should facilitate seamless wireless transmission of location data to a user's mobile device, providing effective position tracking and retrieval capabilities irrespective of environmental conditions. By addressing these challenges, the technology would significantly enhance the accuracy and efficiency of arrow location tracking.

### BRIEF SUMMARY OF THE INVENTION

The present invention provides among other things a nock with an inner housing that can be designed to enclose a micro-GPS module. The nock can also contain a plunger that slides within nock, wherein the plunger can selectively turn on or off the GPS module. The GPS module can be coupled to a micro-controller (MCU) which also includes a light. The MCU, GPS, and light can all be connected to a power source. The system can have a switch mechanism that can be engaged by the plunger when the nock is secured onto a bowstring, initiating the GPS module and light. The plunger can be slidably coupled to a spring that keeps the plunger in an extended position.

The MCU can control both the GPS module and the light, ensuring the components are activated only when the plunger has been activated by the bow string. The light can be positioned to emit visible illumination from the nock, signaling GPS activation. The MCU can be configured to transmit GPS data wirelessly to a paired mobile device for real-time location tracking. This is achieved through the MCU's communication capabilities configured to transmit GPS data wirelessly paired to a user's mobile device.

The method for tracking an arrow involves installing a nock including a GPS module on the arrow, configuring a MCU to interface with the GPS Module and a switch mechanism, employing a plunger to interact with the switch mechanism and control the activation of the GPS module upon securing the nock to a bowstring, and transmitting location data from the GPS module to a portable computing device via wireless communication interface within the micro-controller.

In certain embodiments, the arrow tracking system can comprise a two-unit configuration that includes at least one transmitter unit housed within the nock and at least one receiving unit carried by the user. The transmitter unit can contain a micro-controller (MCU) coupled to a nock GPS module, a nock transceiver, and a power source, all enclosed within the nock's inner housing. The transmitter unit can also include a switch coupled to the MCU and a plunger that slides within the nock, wherein the plunger can selectively turn the nock GPS on or off.

The receiving unit can comprise a receiving controller that is coupled to a receiver GPS module and a receiver transceiver. The receiving controller can be configured to receive and process tracking data transmitted from the transmitter unit, enabling the system to provide both distance and directional bearing between the transmitter unit and the receiving unit. This two-unit design allows the user to locate the arrow with enhanced precision and navigational guidance.

The receiving unit can further include a screen configured to display the transmitter's position and the receiver's position relative to the transmitter unit, providing visual feedback to aid in arrow recovery. The distance calculations provided by the system can include both horizontal distance and vertical distance, giving the user comprehensive spatial information about the arrow's location.

In preferred embodiments, the MCU, nock GPS module, and nock transceiver can be assembled in a compact configuration having a diameter of less than 5.5 millimeters, while the inner housing can have an inner diameter of approximately 5.8 to 6.5 millimeters. This miniaturized design ensures minimal impact on arrow weight and aerodynamics.

The receiving controller can be implemented as a single board computer with a dedicated input/output controller, providing robust processing capabilities in a portable form factor. The receiving unit can be designed to communicate wirelessly with a user's mobile device, such as a smartphone or tablet, to display tracking information on the mobile device's screen.

The receiving unit can feature custom software programs or mobile applications that plot the position of both the transmitter unit and the receiving unit in real-time on a previously downloaded topographical map. The receiving unit can be configured to receive periodic data transmissions from the transmitter unit at a predetermined periodic update rate.

It is an object of the invention to provide a system that is designed to be user-friendly, with the ability to wirelessly transmit the GPS data to a user's portable computing device, such as a smartphone or tablet.

It is another object of the invention to track the arrow's location in real-time, enhancing the user's ability to locate the arrow quickly and efficiently.

The above and other objects may be achieved using devices involving an arrow and a mobile platform for finding an arrow after it has been shot from a bow. The platform can be any suitable map platform that shows the user's location and area in real-time.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function.

Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF DRAWINGS

These and other features, aspects, and advantages of the present specification will become better understood with regard to the following description, appended claims, and accompanying drawings where:

FIG. 1 is an isometric view of the arrow tracking system in accordance to one, or more embodiments;

FIG. 2 is a side view of the arrow tracking system in accordance to one, or more embodiments;

FIG. 3a is a back view of the arrow tracking system in accordance to one, or more embodiments;

FIG. 3b is a cross-sectional view of FIG. 3a of the arrow tracking system in accordance to one, or more embodiments;

FIG. 4a is a back view of another embodiment of the arrow tracking system in accordance to one, or more embodiments;

FIG. 4b is a cross-sectional view of FIG. 4b of another embodiment of the arrow tracking system in accordance to one, or more embodiments;

FIG. 5 is an overall side view of the arrow tracking system in accordance to one, or more embodiments; and

FIG. 6 is an overall system view of the arrow tracking system wireless connect to a mobile device in accordance to one, or more embodiments.

FIG. 7 is an isometric view of a transmitter unit in accordance to one, or more embodiments.

FIG. 8 is an isometric view of an open receiver unit in accordance to one, or more embodiments.

FIG. 9 is an diagram depicting the operation of a transmitter unit and receiver unit in the field in accordance to one, or more embodiments.

FIG. 10 is an isometric view of a closed receiver unit in accordance to one, or more embodiments.

Elements and acts in the figures are illustrated for simplicity and have not necessarily been rendered according to any particular sequence or embodiment.

### DETAILED DESCRIPTION OF THE INVENTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

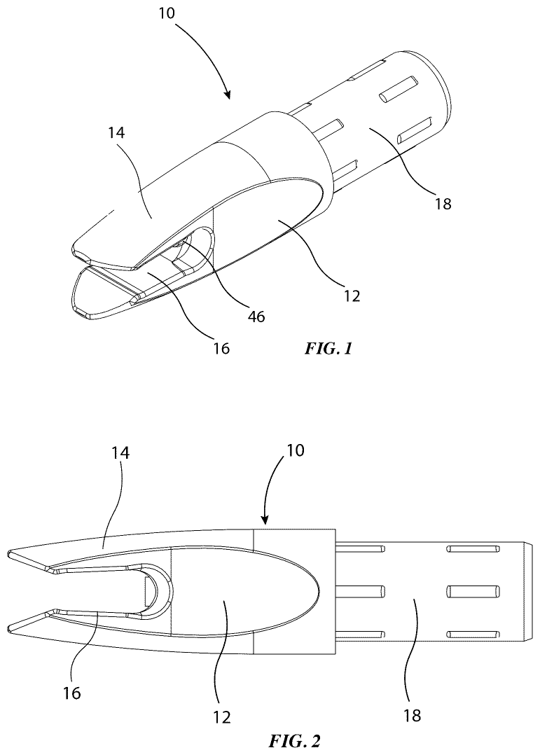

Referring initially to FIG. 1-3b, an arrow tracking system is shown generally at 10. The arrow tracking system that addresses the need for a reliable and efficient method of locating arrows after they have been launched. The arrow can comprise an arrow tracking system 10, a arrow shaft 20, and a broadhead 22 as shown in FIG. 5. The arrow tracking system 10 can be designed to be user-friendly and to provide real-time tracking data, enhancing the user's ability to recover arrows and potentially locate game. The arrow tracking system 10 can have an inner housing 13 wherein the inner housing can house a global positioning system (GPS) module 34, which ensures that the GPS module is securely housed within the nock and is protected from damage and forces on the arrow during the arrow's release, flight and impact.

In some embodiments, the arrow tracking system can comprise a two-unit configuration designed to operate in remote locations outside of typical reliable cellular communication coverage. This embodiment includes a transmitter unit 100 housed within the arrow nock 101 and at least one receiving unit 200 carried by the user. The transmitter unit 100 and receiving unit 200 can be configured to communicate wirelessly using long-range communication protocols, enabling tracking capabilities over extended distances without reliance on cellular networks.

The transmitter unit 100 can be configured to collect global positioning data through an onboard system in a package (siP) global navigation satellite system (GNSS) microchip 102. The GNSS microchip 102 can collect coordinates that are subsequently transmitted to the receiving unit 200. In certain embodiments, a micro-controller 104 can be provided within the transmitter unit 100 to receive positioning data from the onboard GNSS siP 102 using Universal Asynchronous Receiver-Transmitter (UART) hardware communication protocol. The micro-controller 104 can be configured to parse latitude and longitude data from the GNSS data and transmit the parsed data to an onboard wireless transceiver 106.

In certain embodiments, the wireless communication between the transmitter unit 100 and the receiving unit 200 can utilize LoRa (Long Range) modulation technology providing line-of-sight communication capabilities. The parsed positioning data can be transmitted at a defined periodic rate ranging from approximately 15 to 30 seconds, allowing the transmitter unit 100 to enter a sleep mode between transmissions to minimize power consumption and extend battery life.

The transmitter unit can comprise at least three system in a package (siP) microchips mounted on a custom engineered printed circuit board (PCB). These microchips can include an 8-bit micro-controller unit (MCU) 104, a standard positioning GNSS siP microchip 102, and a LoRa transceiver siP microchip 106. Each microchip can be designed for very low power consumption and can range in size from approximately 3 millimeters to 4.5 millimeters. The PCB can further include at least one antenna such as a GNSS patch antenna and a LoRa PCB antenna to facilitate wireless communication and satellite signal reception.

The transmitter unit 100 can be powered by a battery 108 and in a particular embodiment multiple rechargeable lithium manganese dioxide batteries or high-performance micro batteries configured in parallel to achieve a desired operating voltage. The system input power can range between approximately 1.8 volts and 3.3 volts configured for efficient operation while maintaining a compact form factor suitable for integration within an arrow nock 101.

Prior to transmitting GNSS data, the transmitter unit 100 LoRa transceiver 106 can be configured to check a standard communication channel for activity. If activity is detected on the channel, the transceiver can automatically select an alternative channel, thereby allowing multiple transmitter units to be tracked simultaneously by one or more receiving units without signal interference.

The transmitter unit 100, including the PCB, batteries, and antennas, can be housed within a custom hunting nock 101. In a particular embodiment, the hunting nock can be carbon fiber or plastic injection molded. The inner diameter of the nock can be hollow or specifically molded to accommodate the transmitter unit PCB, batteries, and antennas, which can have an approximate diameter of 5.5 millimeters. The inner diameter of the nock housing can range from approximately 5.8 millimeters to 6.5 millimeters to provide adequate clearance while maintaining structural integrity and minimizing added weight to the arrow.

The receiving unit 200 can comprise a computing device 204 configured to receive, process, and display tracking data transmitted from one or more transmitter units. In certain embodiments, the receiving unit can be based on a single board computer (SBC) with a dedicated input/output controller. The receiving unit can include Wi-Fi capability and USB ports 205 for archiving hunt tracking data with additional metadata describing each hunt. The Wi-Fi connectivity can enable access to a cloud-based data platform for tracking multiple hunts and for selected group distribution of hunt data. Tracking data can be archived using USB storage devices for later retrieval or uploaded to a cloud web platform 300 when within range of a Wi-Fi signal.

In various embodiments, the receiving unit can be configured in multiple form factors. A first configuration, receiving unit A, can comprise a tablet-like device approximately the size of a small tablet or large cellular phone with a touch screen monitor for direct user interface. A second configuration, receiving unit B, can comprise a compact micro-controller with Bluetooth wireless communication capability but without an integrated monitor. In this configuration, data can be transmitted from receiving unit B via Bluetooth to a user's cellular phone or other mobile device, where tracking information can be displayed using a custom Android or Apple iOS application. Both receiving unit configurations can function equivalently in terms of data processing and communication capabilities.

Both receiving unit configurations can include onboard GNSS 202 and LoRa modulation modules 206. The GNSS module 202 can enable the receiving unit 200 to collect its own positional data, including latitude and longitude coordinates. The LoRa module 206 can operate in the same frequency range and channel configuration as the transmitter unit 100, enabling controlled access to radio signals and allowing multiple receiving units to access the same live tracking data from one or more transmitter units. Each receiving unit 200 can be powered by rechargeable batteries 208 providing approximately 5 volts of operating power. The batteries 208 can be removably coupled to the receiving unit 200, allowing users to exchange depleted batteries with previously charged spare batteries for extended operation in the field.

The receiving unit 200 can be configured to receive periodic data from the transmitter unit 100 through its onboard LoRa module 206. A custom software program or mobile application can be configured to plot both the transmitter unit position data and the receiving unit position data in real-time on a previously downloaded topographical map. The position data can be updated at the same periodic rate at which data is received from the transmitter unit, providing continuous tracking information. The software or application can further calculate and display tracking metrics such as horizontal distance, vertical distance, elapsed time, velocity, and directional bearing between the receiving unit and the transmitter unit.

In certain embodiments, tracking paths for both the user carrying the receiving unit 200 and the arrow containing the transmitter unit 100 can be continuously updated and displayed on a topographical hunting or trail map at the defined periodic update rate. All tracking data from each use can be automatically saved to a storage device 210 within the receiving unit 200 for subsequent archiving or post-use upload to a cloud-based web platform. In optional configurations, the receiving unit 200 can include a cellular communication module to provide live tracking data uploads to the cloud platform when cellular service coverage is available. The cellular module can further be configured to transmit notification messages to the cloud web platform, which can be accessed by the public or a pre-defined selected group of users, to request assistance in locating or retrieving a downed animal.

The two-unit system embodiment enables operation with multiple transmitter units and multiple receiving units within a defined geographical area. The transmitter unit 100 housed within the arrow nock 101 is configured to collect and transmit geographical positioning data at regular intervals. The receiving unit 200 is configured to receive geographical data from one or more transmitter units 100 while simultaneously collecting its own geographical position data. A custom application or program displays real-time tracking data for both the user and the arrow on a topographical map interface, with all data stored within the receiving unit for later analysis or cloud platform upload. This configuration may provide enhanced tracking capabilities in remote areas where cellular communication is unavailable or unreliable, significantly improving the user's ability to locate arrows and track game animals after a shot.

The inner housing 13 can be substantially the same shape as the nock or can be such as, for example, square, rectangular, circular or the like allowing enough space for the tracking system components. In certain embodiments, the GPS module 34 can be coupled to printed circuit board (PCB) 32 which can be coupled to a micro-controller (MCU) 36. The PCB 32, MCU 36 and GPS 34 can fit within the inner compartment. The GPS can be such as, for example, nano-GPS, Nano Spider GPS module, Nano Hornet, SimCom SIM28, Telit SL869, or any other nano-GPS module known in the art. The MCU can be such as, for example, ATtiny microchip, STM32L0, ESP8285, or any other nano-MCU known in the art. In certain embodiments, the PCB can be omitted, and the GPS can have its own MCU and PCB to wirelessly transmit its location to the user. In other embodiments, the MCU 36 can be coupled to the GPS module, allowing for efficient communication between the two components. The MCU 36 can be configured to transmit the location of the arrow wirelessly to the portable computing device 50, enabling real-time location tracking.

In certain embodiment, the MCU or PCB can further comprise a light 35 which can be such as, for example, micro-light emitting diode (LED), fiber optic light, last diodes, micro-UV LEDs or the like. The light 35 can either light up the nock or can light up a hole within the nock allowing the user to see if the GPS is on or off. The light 35 can be separate of the MCU or PCB or can be omitted and the user can detect whether the GPS is on by such as, for example, the portable computing device, portable app, or the like. The light 35 can be positioned to emit visible illumination from the nock, signaling the activation of the GPS module.

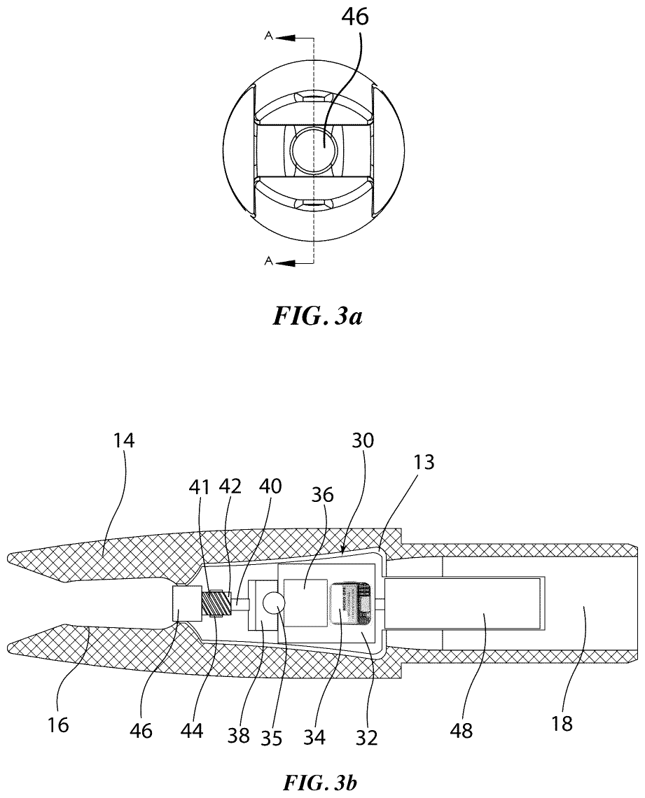

In embodiments, the MCU 36 and the GPS 34 can be coupled to a printed circuit board (PCB) that can be housed within the nock 10 or in other embodiment, as shown in FIG. 3b, can be housed in a protective housing 30. The housing 30 can be sized to fit the electrical components and to slidably capture a plunger 46. The housing 30 can have a plunger guide 44 which can allow the plunger to slidably move in and out and allow a spring 41 to be captured which can keep the plunger in its extended position. This design allows the plunger to engage the switch when the nock is secured onto a bowstring, initiating the GPS module and the light. The plunger 46 can be any suitable shape and size but in the preferred embodiment, the plunger can be sized to fit within the nock 10.

In embodiments, a power source 48 can power at least one of the MCU 36, the GPS 34, the switch 38 and the light 35 and at least one can be coupled to the power source 48. The power source can be housed within a nock fitting 18 which can be coupled to the arrow shaft 20. The power source 48 can be such as, for example, coin cell batteries, lithium polymer battery, thin film battery, micro-cell battery, or the like. The power source 48 can be removable from the nock fitting 18 wherein the user can replace the power source and insert a new power course. The power source 48 can be lightweight and compact minimally affecting the flight and balance of the arrow. In certain embodiments, the power source 48 can be rechargeable and can maintain performance during the release and flight and after flight and impact.

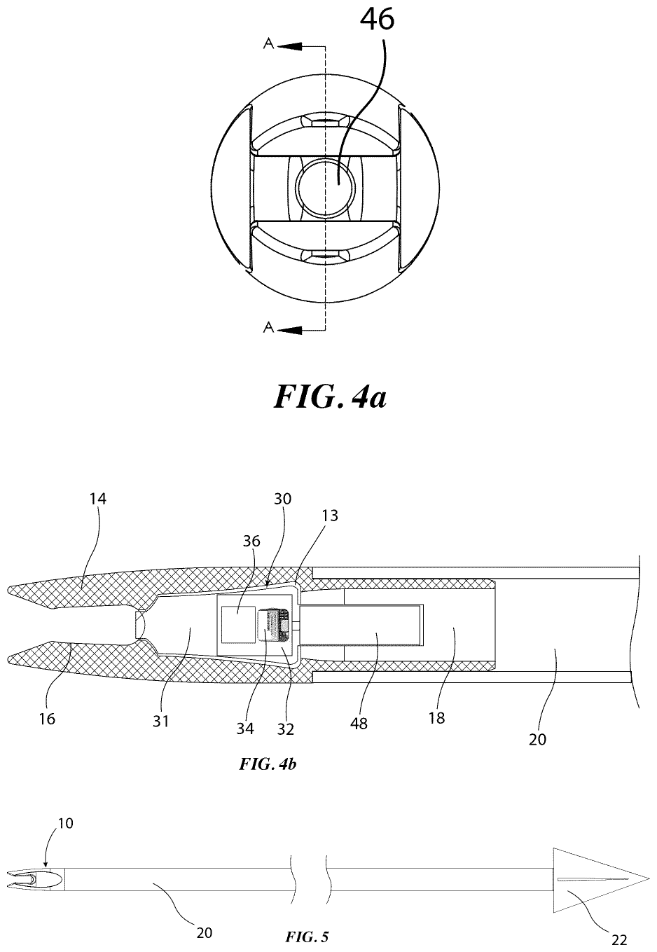

In certain embodiments, the plunger 46 can be omitted as shown in FIG. 4a-4b. In embodiment, the plunger 46 can have a plunger body 42 that can be slidably coupled to plunger guide 44 and the plunger can be such as, for example, circular, square, rectangular, polygonal or the like in shape. The plunger 46 can be a micro-plunger and light weight as to not add any substantial weight to the nock. The plunger guide 44 can be on a slide rail or linear bearing allowing the nock to easily slide within the inner housing 13. The plunger guide 44 can be integral or separate of the inner housing 13. The spring 41 can be such as, for example, a micro spring, compression spring, extension spring, wave spring or the like. In certain embodiments, the spring can be omitted. The plunger 46 or switch 38 can be designed to selectively turn the GPS module 34 on or off, providing the user with control over the tracking system. The MCU 36 can control both the GPS module 34 and the light 35, ensuring that these components are activated only when the plunger 46 is in a specific position upon nocking.

In embodiments, the arrow tracking system 10 can include a switch 38 that can be coupled to the MCU 36 wherein the plunger 46 can come into contact with the spring 41 turning on and off the GPS. The plunger 46 can also be slidably coupled to a spring 41 that keeps the plunger in an extended position and the switch 38 deactivated. In other embodiments, the switch 38 can be a button that can partially protrude from the housing 12 or can be indented in the nock. The arrow tracking system further includes a portable computing device 50 that is wirelessly coupled to the GPS module 34 which can allow the user to locate the arrow by receiving GPS data from the module. The arrow tracking system 10 compact design allows for the GPS module 34 to be housed within the inner housing 13 without significantly altering the weight or balance of the arrow allowing the user to easily find a shot arrow or animal that has been shot.

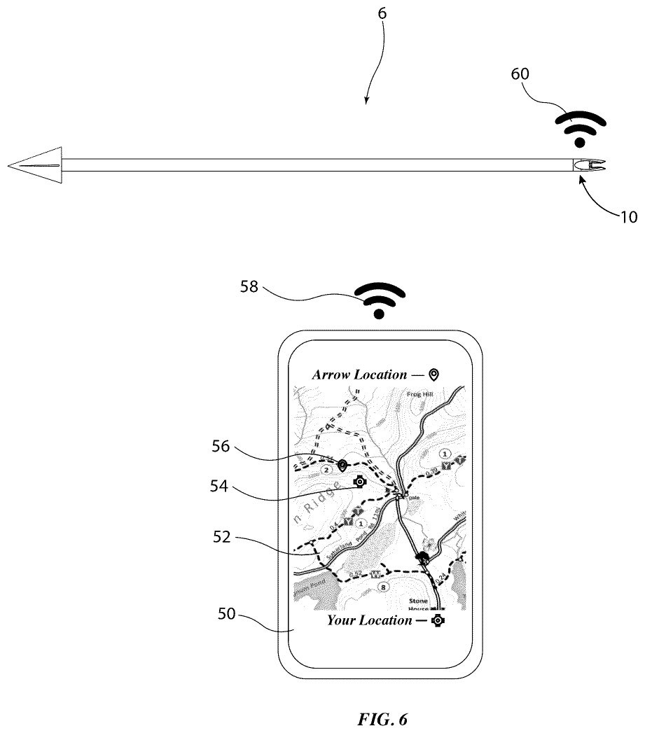

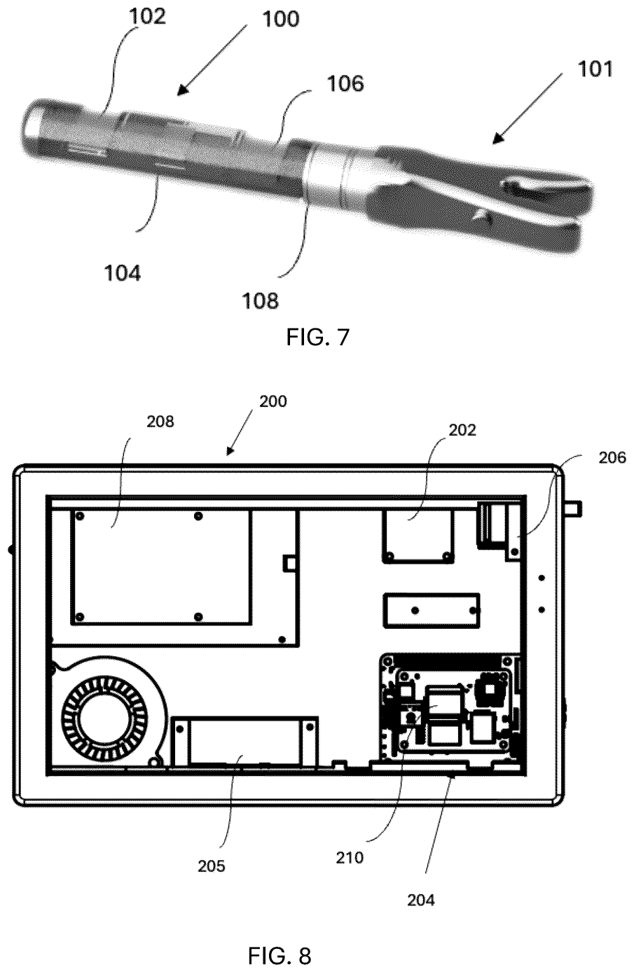

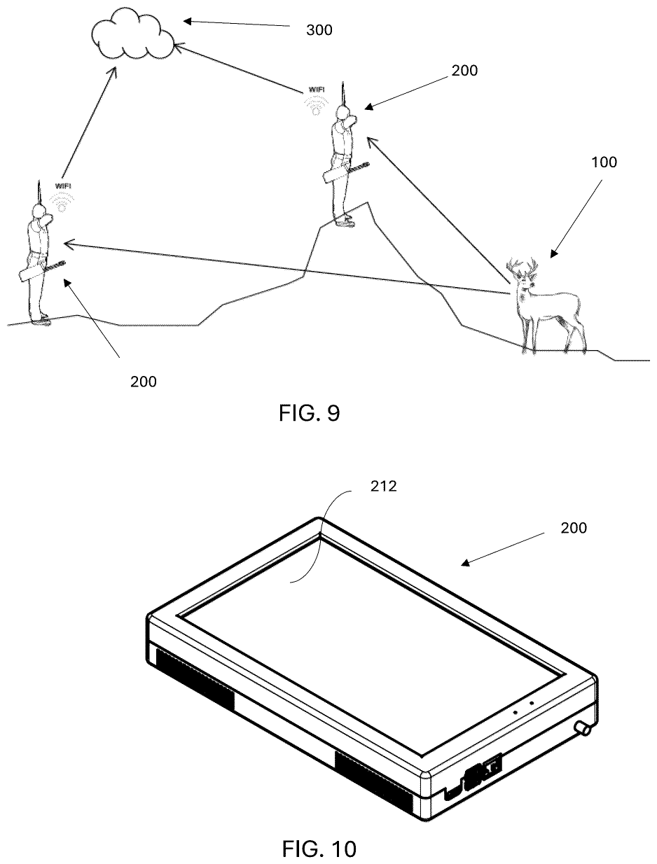

As shown in FIG. 6, the arrow 6 can be shot from a bow wherein the arrow tracking system 10 can send an arrow signal to a portable computing device 50 wherein the portable computing device can receive the signal 58. The portable computing device 50 can use an existing mobile application map platform or can use its own wherein the map can show the topographical area 52 the user is in including the user's location 54 and the arrow's location 56. The user's location can be updated in real-time directing the user to the arrow's location 56.

The method for tracking an arrow involves installing a nock that includes a GPS module on the arrow. The MCU is configured to interface with the GPS module and a switch mechanism. The plunger is employed to interact with the switch mechanism and control the activation of the GPS module upon securing the nock to a bowstring. A spring load mechanism is utilized to maintain the plunger in an extended position, engaging only during the nocking process or to turn off the GPS and light. The location data from the GPS module is transmitted to a portable computing device via a wireless communication interface within the MCU. The GPS remains active until the user presses the plunger, turning off the system. This arrow tracking system and method provide a reliable and efficient solution for locating arrows after they have been launched. The system is user-friendly and provides real-time tracking data, the user's ability to recover arrows and potentially locate game.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

We claim:

1. An arrow tracking system for tracking an arrow, the system comprising:
a nock having an inner housing configured to enclose a global position system (“GPS”) module;
a switch coupled to a micro-controller (“MCU”) wherein the MCU is coupled to the GPS;
a plunger that slides within the nock wherein the plunger selectively turns on or off the GPS;
a portable computing device wirelessly coupled to the GPS allowing the user to locate the arrow.

2. The arrow tracking system of claim 1, wherein the MCU further comprises a light.

3. The arrow tracking system of claim 1, wherein the GPS, MCU and light are coupled to a power source.

4. The arrow tracking system of claim 2, wherein the switch is engaged by the plunger when the nock is secured onto a bowstring, initiating the GPS module and light.

5. The arrow tracking system of claim 2, wherein the plunger can be slidably coupled to a spring that keeps the plunger in an extended position.

6. The arrow tracking system of claim 1, wherein the MCU controls both the GPS module and light, ensuring the components are activated only when the plunger is in a specific position upon nocking.

7. The arrow tracking system of claim 1, wherein the light is positioned to emit visible illumination from the nock, signaling GPS activation.

8. The arrow tracking system of claim 1, wherein the MCU is configured to transmit GPS data wirelessly to a paired mobile device for real-time location tracking.

9. The arrow tracking system of claim 1, wherein the MCU includes communication capabilities configured to transmit GPS data wirelessly paired to a user's mobile device, enabling real-time location tracking.

10. The arrow tracking system of claim 1, wherein the GPS is a micro-GPS.

11. A method for tracking an arrow, comprising:
installing a nock including a GPS module on the arrow;
configuring a MCU to interface with the GPS Module and a switch mechanism;
employing a plunger to interact with the switch mechanism and control the activation of the GPS module upon securing the nock to a bowstring;
utilizing a spring load mechanism to maintain the plunger in an extended position, engaging only during the nocking process or to turn of the GPS and light;
transmitting location data from the GPS module to a portable computing device via wireless communication interface within the micro-controller.

12. The method for tracking an arrow claim 11 wherein the GPS is active until the user presses the plunger turning off the system.

13. An arrow tracking system for tracking an arrow, the system comprising:
At least one transmitter unit and at least one receiving unit;
wherein the at least one transmitter unit comprises:
a nock having an inner housing enclosing a micro-controller (MCU) coupled to a nock global position system (“GPS”) module, a nock transceiver, and a power source;
a switch coupled to the MCU;
a plunger that slides within the nock wherein the plunger selectively turns on or off the nock GPS;
wherein the at least one receiving unit comprises:
a receiving controller coupled to a receiver GPS module and a receiver transceiver;
wherin the receiving controller receives and processes tracking data from the at least one transmitter unit to provide a distance and a directional bearing between the at least one transmitter unit and the at least one receiver unit.

14. The arrow tracking system of claim 13 wherein the receiving unit further comprises a screen to display a transmitter position of the at least one transmitter unit and a receiver position of the at least one receiving unit relative to the at least one transmitter unit.

15. The tracking system of claim 13 wherein the distance includes a horizontal distance and a vertical distance.

16. The tracking system of claim 13 wherein the MCU, the nock GPS, and the nock transceiver are in an assembly having a diameter less than 5.5 mm and the inner housing has an inner housing inner diameter of approximately 5.8 to 6.5 mm.

17. The tracking assembly of claim 13 wherein the receiving controller is a single board computer with a dedicated input/output controller.

18. The tracking assembly of claim 13 wherein the receiving unit communicates with a user's mobile device to display tracking information on the mobile device.

19. The tracking assembly of claim 13 wherein the receiving unit has a custom software program or mobile application that plots the position of the at least one transmitter unit and the at least one receiving unit in real time on a previously downloaded topographical map.

20. The tracking assembly of claim 13 wherein the receiving unit receives periodic data from the transmitter unit at a predetermined periodic update rate.
